(19) United States
(12) Patent Application Publication
(10) Pub. No.: US 2025/0206272 A1
(43) Pub. Date: Jun. 26, 2025

(54) SYSTEMS AND METHODS FOR A TRAILER OPERABLY COUPLED WITH A WORK VEHICLE

(71) Applicant: CNH Industrial America LLC, New Holland, PA (US)

(72) Inventor: Sudarshan Sirigere, Naperville, IL (US)

(21) Appl. No.: 18/390,350

(22) Filed: Dec. 20, 2023

(51) Int. Cl. B60T 7/20; B60T 7/04; B60T 8/171; B60T 8/92; B60T 13/14; B60T 13/68; B60T 17/04; B60T 17/22

(52) U.S. Cl. CPC B60T 7/20; B60T 7/04; B60T 8/171; B60T 8/92; B60T 13/147; B60T 13/686; B60T 17/04; B60T 17/22

(57) ABSTRACT

A brake control system includes a trailer brake valve fluidly interposed between a vehicle brake assembly and a trailer brake assembly. A brake module is operably coupled with the vehicle brake assembly and configured to provide a first signal to the trailer brake valve. A control valve is configured to provide a second signal to the trailer brake valve. The trailer brake valve is operated based on the first signal when the vehicle is operated in a first mode and operated based on the second signal when the vehicle is operated in a second mode.

### FIELD OF THE INVENTION

The present subject matter relates generally to work vehicles and, more particularly, to a system for controlling a brake assembly of a trailer operably coupled with a work vehicle.

### BACKGROUND OF THE INVENTION

A work vehicle, such as a vehicle, typically includes two brake input devices, each of which is coupled to a corresponding brake cylinder or service brake for braking an associated wheel of the vehicle. For instance, the work vehicle may include a left brake input device hydraulically connected to a left service brake for braking the left rear wheel of the vehicle and a right brake input device hydraulically connected to a right service brake for braking the right rear wheel of the vehicle. In addition to the vehicle service brakes, the work vehicle may also include or be associated with additional brakes, such as one or more trailer brake assemblies of a trailer or other trailer being hauled by the vehicle.

In some instances, the vehicle may implement one or more autonomous or driver assistance operations. In such instances, the one or more trailer brake assemblies of a trailer operably coupled with a work vehicle may be actuated with the assistance of a computing system. Accordingly, an improved system and method for control of the trailer brake assembly would be welcomed in the technology.

### BRIEF DESCRIPTION OF THE INVENTION

Aspects and advantages of the technology will be set forth in part in the following description, or may be obvious from the description, or may be learned through practice of the technology.

In some aspects, the present subject matter is directed to a brake control system that includes a trailer brake valve fluidly interposed between a vehicle brake assembly and a trailer brake assembly. A brake module is operably coupled with the vehicle brake assembly and configured to provide a first signal to the trailer brake valve. A control valve is configured to provide a second signal to the trailer brake valve. The trailer brake valve is operated based on the first signal when a vehicle is operated in a first mode and operated based on the second signal when the vehicle is operated in a second mode.

In some aspects, the present subject matter is directed to a method for operating a brake control system. The method includes providing a first signal to a trailer brake valve based on an actuation of a master brake cylinder when operating a vehicle in a first mode. The method also includes energizing a control valve thereby allowing a proportional pilot pressure to be provided to the trailer brake valve as a second signal when operating a vehicle in a second mode. Lastly, the method includes actuating a trailer brake assembly based on the first signal or the second signal.

In some aspects, the present subject matter is directed to a brake control system that includes a trailer brake valve fluidly interposed between a vehicle brake assembly and a trailer brake assembly, the trailer brake assembly including one or more control line brakes fluidly coupled with a first fluid circuit and one or more supplementary line brakes fluidly coupled with a second fluid circuit. A brake module is operably coupled with the vehicle brake assembly and configured to provide a first signal to the trailer brake valve. A control valve is configured to provide a second signal to the trailer brake valve. The trailer brake valve is operated based on the first signal when a vehicle is operated in a first mode and operated based on the second signal when the vehicle is operated in a second mode. The first fluid circuit is segregated from the second fluid circuit.

These and other features, aspects, and advantages of the present technology will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present technology, including the best mode thereof, directed to one of ordinary skill in the art, is set forth in the specification, which makes reference to the appended figures, in which:

FIG. 1 illustrates a side view of a work vehicle hauling or towing a given a trailer in accordance with aspects of the present subject matter;

FIG. 2 illustrates a schematic view of the vehicle and the trailer in accordance with aspects of the present subject matter;

FIG. 3 illustrates a circuit diagram of a system for braking the vehicle and the trailer in accordance with aspects of the present subject matter; and

FIG. 4 illustrates a flow diagram of a method for operating A brake control system in accordance with aspects of the present subject matter.

Repeat use of reference characters in the present specification and drawings is intended to represent the same or analogous features or elements of the present technology.

### DETAILED DESCRIPTION OF THE INVENTION

Reference now will be made in detail to embodiments of the disclosure, one or more examples of which are illustrated in the drawings. Each example is provided by way of explanation of the discourse, not limitation of the disclosure. In fact, it will be apparent to those skilled in the art that various modifications and variations can be made in the present disclosure without departing from the scope or spirit of the disclosure. For instance, features illustrated or described as part can be used with another embodiment to yield a still further embodiment. Thus, it is intended that the present disclosure covers such modifications and variations as come within the scope of the appended claims and their equivalents.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

As used herein, the terms “first,” “second,” and “third” may be used interchangeably to distinguish one component from another and are not intended to signify a location or importance of the individual components. The terms “coupled,” “fixed,” “attached to,” and the like refer to both direct coupling, fixing, or attaching, as well as indirect coupling, fixing, or attaching through one or more intermediate components or features, unless otherwise specified herein. The terms “upstream” and “downstream” refer to the relative direction with respect to an agricultural product within a fluid circuit. For example, “upstream” refers to the direction from which an agricultural product flows, and “downstream” refers to the direction to which the agricultural product moves. The term “selectively” refers to a component's ability to operate in various states (e.g., an ON state and an OFF state) based on manual and/or automatic control of the component.

Furthermore, any arrangement of components to achieve the same functionality is effectively “associated” such that the functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected” or “operably coupled” to each other to achieve the desired functionality, and any two components capable of being so associated can also be viewed as being “operably couplable” to each other to achieve the desired functionality. Some examples of operably couplable include, but are not limited to, physically mateable, physically interacting components, wirelessly interactable, wirelessly interacting components, logically interacting, and/or logically interactable components.

The singular forms “a,” “an,” and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about,” “approximately,” “generally,” and “substantially,” is not to be limited to the precise value specified. In at least some instances, the approximating language may correspond to the precision of an instrument for measuring the value, or the precision of the methods or apparatus for constructing or manufacturing the components and/or systems. For example, the approximating language may refer to being within a ten percent margin.

Moreover, the technology of the present application will be described in relation to exemplary embodiments. The word “exemplary” is used herein to mean “serving as an example, instance, or illustration.” Any embodiment described herein as “exemplary” is not necessarily to be construed as preferred or advantageous over other embodiments. Additionally, unless specifically identified otherwise, all embodiments described herein should be considered exemplary.

As used herein, the term “and/or,” when used in a list of two or more items, means that any one of the listed items can be employed by itself, or any combination of two or more of the listed items can be employed. For example, if a composition or assembly is described as containing components A, B, and/or C, the composition or assembly can contain A alone; B alone; C alone; A and B in combination; A and C in combination; B and C in combination; or A, B, and C in combination.

As used throughout this disclosure, the term “autonomous” refers to a vehicle capable of implementing at least one operation without driver input. An “operation” refers to a change in one or more of the steering, braking, acceleration/deceleration of the vehicle, actuation of a component of an implement, actuation of a component of a trailer, and/or actuation of any other component of the vehicle and/or any assembly operably coupled with the vehicle. The term “semi-autonomous” refers to a vehicle capable of implementing at least one operation that is not fully automatic but assists the operator with such operation (e.g., fully operational without a driver or without driver input). As such an autonomous vehicle includes those that can operate under operator control during certain time periods and without operator control during other time periods while a semi-autonomous vehicle includes those that can operate under operator control during certain time periods and assist with operator control during other time periods.

In general, the brake control system provided herein can include a trailer brake valve fluidly interposed between a vehicle brake assembly and a trailer brake assembly. A brake module can be operably coupled with the vehicle brake assembly and can be configured to provide a first signal to the trailer brake valve. A control valve can be configured to provide a second signal to the trailer brake valve. The trailer brake valve can be operated based on the first signal when the vehicle is operated in a first mode and operated based on the second signal when the vehicle is operated in a second mode.

In various examples, the trailer brake assembly can include a control line brake (e.g., a service brake) and/or a supplementary line brake (e.g., an emergency brake). In some cases, the control line brake may form and/or be part of a first fluid circuit, and the supplementary line brake may form and/or be part of a second fluid circuit. In various examples, the first fluid circuit may be independent and/or fluidly segregated from the second fluid circuit. Moreover, the fluid within the first fluid circuit may be a first fluid and the fluid within the second fluid circuit may be a second fluid that is varied from the first fluid.

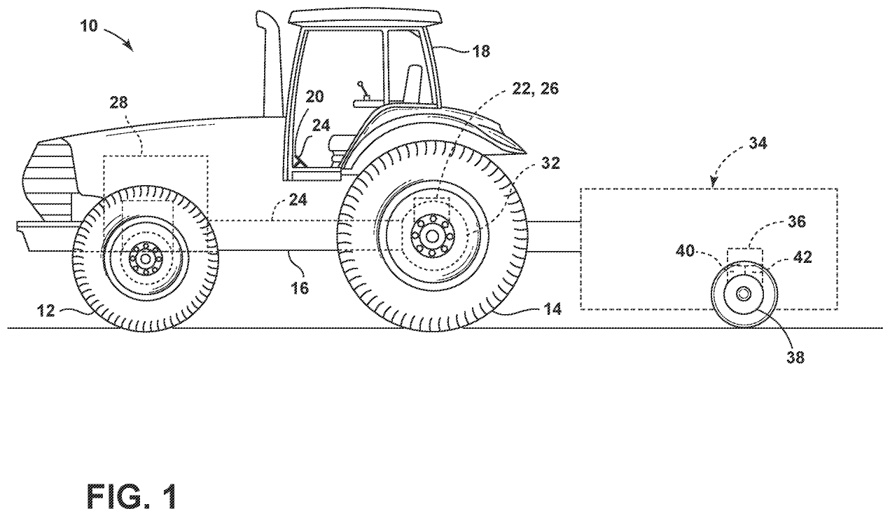

Referring now to FIG. 1, a work vehicle 10 is illustrated in accordance with aspects of the present subject matter. As shown, the work vehicle 10 is configured as an agricultural vehicle. However, in other embodiments, the work vehicle 10 may be configured as any other suitable work vehicle known in the art, such as various other agricultural vehicles and/or the like.

As shown in FIG. 1, the work vehicle 10 includes a pair of front wheels 12, a pair of rear wheels 14, and a chassis 16 coupled to and supported by the wheels 12, 14. An operator's cab 18 may be supported by a portion of the chassis 16 and may house various control devices (e.g., levers, pedals, control panels, and/or any other device) for permitting an operator to control the operation of the work vehicle 10. For example, a first brake input device 20 may be provided within the cab 18 for actuating a first service brake 22 configured to brake the left rear wheel 14 of the work vehicle 10. Additionally, a second brake input device 24 may be provided within the cab 18 for actuating a second service brake 26 configured to brake the right rear wheel 14 of the work vehicle 10. However, in some cases, the first brake input device 20 can actuate the first service brake 22 and the second service brake 26 in conjunction with one another. In various examples, each of the first brake input device 20 and the second brake input device 24 may be in the form of a pedal, a keypad, a touchpad, a knob, a button, a sliders, a switch, a microphone, and/or any other device configured to receive inputs from the operator.

Moreover, the work vehicle 10 may include a power plant 28 and a transmission 30 mounted on the chassis 16. The transmission 30 may be operably coupled to the power plant 28 and may provide variably adjusted gear ratios for transferring power plant power to the wheels 12, 14 via a differential 32. The power plant 28, transmission 30, and differential 32 may collectively define a drive train of the work vehicle 10.

As illustrated in FIG. 1, the work vehicle 10 may be configured to haul or tow a suitable trailer 34. In general, the trailer 34 may correspond to any suitable unit that may be hauled or towed by the vehicle 10, including, but not limited to, towed units intended to carry a load and equipment or implements capable of performing a desired operation or function, such as ground handling equipment, fertilizer spreaders, sprayers and/or the like. As shown in FIG. 1, the trailer 34 may include a trailer brake assembly 36 configured for braking one or more associated wheels 38 of the trailer 34. In various examples, the trailer brake assembly 36 can include a control line brake 40 (e.g., a service brake) and/or a supplementary line brake 42 (e.g., an emergency brake).

It will be appreciated that the configuration of the work vehicle 10 described above and shown in FIG. 1 is provided only to place the present subject matter in an exemplary field of use. Thus, it will be appreciated that the present subject matter may be readily adaptable to any manner of work vehicle configuration. For example, in an alternative embodiment, a separate frame or chassis 16 may be provided to which the power plant 28, transmission 30, and differential 32 are coupled, a configuration common in smaller vehicles. Still, other configurations may use an articulated chassis to steer the work vehicle 10 or rely on tracks in lieu of tires.

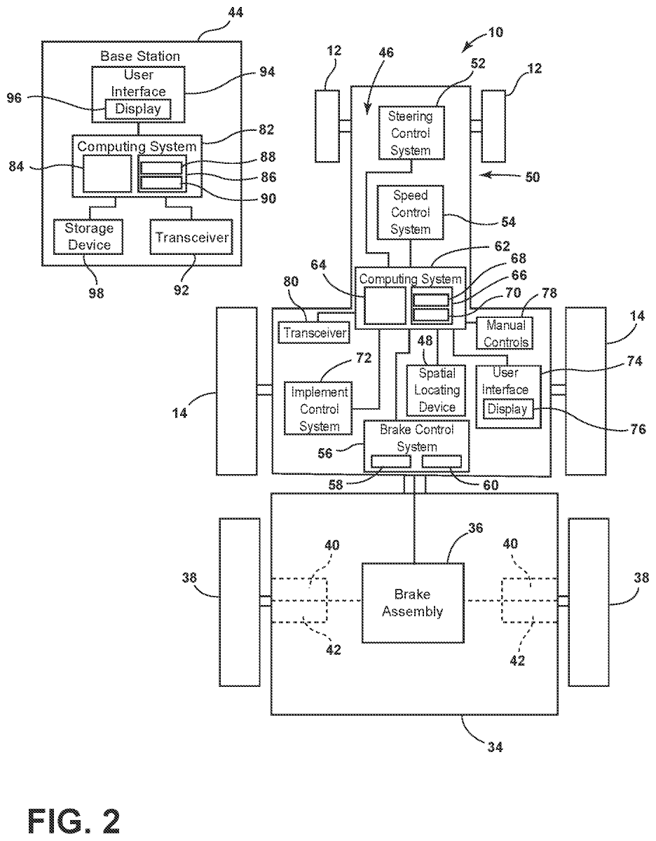

Referring to FIG. 2, a brake control system 56 can include the work vehicle 10, a trailer 34, and/or a base station 44. Moreover, the work vehicle 10 can include a control system 46 configured to assist, perform, or otherwise facilitate operations (e.g., vehicle movement operations, planting operations, seeding operations, application operations, tillage operations, harvesting operations, etc.). For example, the control system 46 may automatically guide the work vehicle 10 to perform certain operations.

In some cases, the control system 46 includes a spatial locating device 48, which can be mounted to the work vehicle 10 and configured to determine a position and, in certain cases, a velocity of the work vehicle 10. The spatial locating device 48 may include any suitable system configured to measure and/or determine the position of the work vehicle 10, such as a GPS receiver, for example.

In the illustrated example, the control system 46 can include a movement control system 50. In various examples, the movement control system 50 can include a steering control system 52 configured to control a direction of movement of the work vehicle 10, a speed control system 54 (which can include the power plant 28 and the transmission 30) configured to control a speed of the work vehicle 10, and/or a brake control system 56. In some cases, the brake control system 56 may be able to detect when the vehicle is operated in a manually operated mode or an autonomous (or semi-autonomous) mode. In such instances, the brake control system 56 may utilize a manual brake module 58 when operated in a manually operated mode and an autonomous module 60 when operated in an autonomous or semi-autonomous mode.

In addition, the control system 46 includes a computing system 62, which can be communicatively coupled to the spatial locating device 48, the steering control system 52, the speed control system 54, and/or the brake control system 56. In some cases, the computing system 62 can be configured to automatically control the work vehicle 10 during certain phases of agricultural operations (e.g., without operator input, with limited operator input, etc.). In general, the computing system 62 may include any suitable processor-based device, such as a computing device or any suitable combination of computing devices. Thus, in several examples, the computing system 62 may include one or more processors 64 and associated memory device 66 configured to perform a variety of computer-implemented functions. As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. The memory device 66 may store processor-executable instructions (e.g., firmware or software) for the processor 64 to execute, such as instructions for controlling the work vehicle 10, instructions for determining a plan for the work vehicle 10, and so forth. In certain embodiments, the memory device 66 may include one or more tangible, non-transitory, computer-readable media (e.g., machine-readable media) that store instructions 70 executable by the processor 64 (e.g., configured to cause the processor 64 to perform certain operations) and/or data 68 to be processed by the processor 64. The storage device(s) (e.g., nonvolatile storage) may include ROM, flash memory, a hard drive, or any other suitable optical, magnetic, or solid-state storage medium, or a combination thereof. The storage device(s) may store data 68 (e.g., position data, vehicle geometry data, etc.), instructions (e.g., software or firmware for controlling the work vehicle 10, etc.), and any other suitable data. In addition, the computing system 62 may also include various other suitable components, such as a communications circuit or module, one or more input/output channels, a data/control bus, and/or the like.

It will be appreciated that, in several examples, the computing system 62 may correspond to an existing controller of the vehicle 10, or the computing system 62 may correspond to one or more separate processing devices. For instance, in some examples, the computing system 62 may form all or part of a separate plug-in module or computing device(s) that is installed relative to the vehicle 10 to allow for the disclosed system and method to be implemented without requiring additional software to be uploaded onto existing control devices of the vehicle 10.

In various examples, the steering control system 52 may include a wheel angle control system, a torque vectoring system, or a combination thereof. The wheel angle control system may automatically rotate one or more wheels 12, 14, and/or tracks of the work vehicle 10 (e.g., via hydraulic actuators) to steer the work vehicle 10 along a target route through a work area. By way of example, the wheel angle control system may rotate front wheels/tracks, rear wheels/tracks, intermediate wheels/tracks, or a combination thereof, of the work vehicle 10 (e.g., either individually or in groups). In addition, the torque vectoring system may differentially apply torque from a power plant 28 to the wheels 12, 14, and/or track(s) on each lateral side of the work vehicle 10, thereby directing the work vehicle 10 along a path. In further examples, the steering control system may include other and/or additional systems to facilitate directing the work vehicle 10 along a path through the work area.

In various examples, the speed control system 54 may include a power plant output control system, a transmission control system, or a combination thereof. The power plant output control system may vary the output of the power plant 28 to control the speed of the work vehicle 10. For example, the power plant output control system may vary a throttle setting of the power plant 28, a fuel/air mixture of the power plant 28, a timing of the power plant 28, and other suitable power plant parameters to control the power plant output or a combination thereof. In addition, the transmission control system may adjust a gear ratio of a transmission 30 (e.g., by adjusting gear selection in a transmission 30 with discrete gears, by controlling a continuously variable transmission (CVT), etc.) to control the speed of the work vehicle 10. In further examples, the speed control system may include other and/or additional systems to facilitate adjusting the speed of the work vehicle 10.

In various examples, the brake control system 56 may adjust braking force, thereby controlling the speed of the work vehicle 10. In various examples, the brake control system 56 may be configured to control one or more brakes 22, 26 on the vehicle 10 and/or one or more brakes (e.g., a control line brake 40 and/or a supplementary line brake 42) on the trailer 34 hauled by a work vehicle 10. As provided herein, the brake control system 56 may be able to detect when the vehicle 10 is operated in a manually operated mode or an autonomous (or semi-autonomous) mode. In such instances, the brake control system 56 may utilize a manual brake module when operated in a manually operated mode and an autonomous module when operated in an autonomous or semi-autonomous mode for controlling one or more brakes on the trailer 34. For instance, when the vehicle 10 is operated in a manual mode, an input may be provided to a trailer brake valve from a master brake assembly, which in turn, operates the one or more brakes of the trailer 34. When the vehicle 10 is operated in an autonomous or semi-autonomous mode in which the one or more brakes are actuated without direct operator input, a control valve (e.g., a proportional control valve) may provide input to the trailer brake valve, which in turn, operates the one or more brakes of the trailer 34.

Additionally, the control system 46 can include an implement control system 72 configured to control an agricultural implement operably coupled with the work vehicle 10 and/or the trailer 34. The computing system 62, which is communicatively coupled to the implement control system 72, is configured to automatically control the agricultural implement via the implement control system 72 during certain phases of agricultural operations (e.g., without operator input, with limited operator input, etc.). For example, the implement control system 72 may be configured to control a steering angle of the implement (e.g., via an implement steering control system having a wheel angle control system and/or a differential brake control system 56), a speed of the work vehicle 10 (e.g., via an implement speed control system having a brake control system 56), a height of the implement (e.g., via a hitch position control system configured to control a hitch of the work vehicle 10 and/or hitch connection(s) of the implement, via an implement wheel position control system configured to control position(s) of the wheel(s) of the implement), or a combination thereof. Additionally, the implement control system 72 may be configured to control one or more tools of the implement (e.g., via a tool control system), one or more sub-frames of the implement (e.g., via a sub-frame control system), a product flow rate (e.g., via a flow rate control system), a position of the implement relative to the work vehicle 10, or a combination thereof.

In various examples, the implement control system 72 is configured to instruct actuator(s) to adjust a penetration depth of at least one ground-engaging tool of the agricultural implement. By way of example, the implement control system 72 may instruct actuator(s) to reduce or increase the penetration depth of each tillage point on a tilling implement, or the implement control system 72 may instruct actuator(s) to engage or disengage each opener disc/blade of a seeding/planting implement from the soil. Furthermore, the implement control system 72 may instruct actuator(s) to transition the agricultural implement between a working position and a transport position or to adjust a position of a header of the agricultural implement (e.g., a harvester, etc.), among other operations. The work vehicle control system may also include controller(s)/control system(s) for electrohydraulic remote(s), power take-off shaft(s), adjustable hitch(es), or a combination thereof, among other controllers/control systems.

In the illustrated example, the control system 46 includes a user interface 74 (e.g., including a graphical user interface, a GUI) communicatively coupled to the computing system 62. The user interface 74 is configured to enable an operator to control certain parameter(s) associated with the operation of the work vehicle 10 and/or the agricultural implement. For example, the user interface 74 may include a switch that enables the operator to selectively configure the work vehicle 10 for autonomous or manual operation. In addition, the user interface 74 may include a battery cut-off switch, and power plant ignition switch, a stop button, or a combination thereof, among other controls. In various examples, the user interface 74 includes a display 76 configured to present information to the operator, such as a map of the work area, a visual representation of certain parameter(s) associated with the operation of the work vehicle 10 (e.g., fuel level, oil pressure, water temperature, etc.), a visual representation of certain parameter(s) associated with the operation of the agricultural implement coupled to the work vehicle 10 (e.g., seed level, penetration depth of ground engaging tools, orientation(s)/position(s) of certain components of the implement, etc.), or a combination thereof, among other information. In various examples, the display 76 may include a touchscreen interface that enables the operator to control certain parameters associated with the operation of the work vehicle 10 and/or the agricultural implement. For example, the user interface 74, via the display 76, may enable the operator to identify actions to be performed and action locations for the identified actions in the work area, and/or the user interface 74, via the display 76, may enable the operator to view transition operations associated with the actions, as determined by the control system 46.

In the illustrated example, the control system 46 can also include manual controls 78 configured to enable an operator to control the work vehicle 10 while automatic control is disengaged (e.g., while unloading the work vehicle 10 from a trailer 34, etc.). The manual control 78 may include manual steering control, manual transmission control, manual braking control, or a combination thereof, among other controls. In the illustrated example, the manual controls 78 are communicatively coupled to the computing system 62. The computing system 62 is configured to disengage automatic control of the work vehicle 10 upon receiving a signal indicative of manual control of the work vehicle 10. Accordingly, if an operator controls the work vehicle 10 manually, the automatic control terminates, thereby enabling the operator to control the work vehicle 10.

With further reference to FIG. 2, the control system 46 can include a transceiver 80 communicatively coupled to the computing system 62. The transceiver 80 is configured to establish a communication link with a corresponding transceiver 92 of a base station 44, thereby facilitating communication between the base station 44 and the control system 46 of the work vehicle 10. The transceiver 80 may operate at any suitable frequency range within the electromagnetic spectrum. In addition, the transceiver 80 may utilize any suitable communication protocol, such as a standard protocol (e.g., Wi-Fi, Bluetooth, etc.) or a proprietary protocol. In various examples, the base station 44 may be a handheld device, a laptop, or another suitable device.

In several examples, the base station 44 includes a computing system 82 communicatively coupled to the base station transceiver 92. The computing system 82 is configured to output commands and/or data 88 to the computing system 62 of the work vehicle 10. For example, the computing system 82 may be configured to determine a plan and to output one or more signals indicative of the plan to the work vehicle computing system 62, thereby enabling the work vehicle computing system 62 to instruct the movement control system 50 to direct the work vehicle 10 along a route of the plan.

In various examples, the computing system 82 is an electronic controller having electrical circuitry configured to process data 88 from certain components of the base station 44 (e.g., the transceiver 92). In the illustrated embodiment, the computing system 82 includes a processor, such as the illustrated processor 84, and a memory device 86. The processor 84 may be used to execute software, such as software for determining a plan, and so forth. Moreover, the processor 84 may include multiple microprocessors, one or more “general-purpose” microprocessors, one or more special-purpose microprocessors, and/or one or more application-specific integrated circuits (ASICS), or some combination thereof. For example, the processor 84 may include one or more reduced instruction set (RISC) processors. The memory device 86 may include a volatile memory, such as RAM, and/or a nonvolatile memory, such as ROM. The memory device 86 may store a variety of data 88 and may be used for various purposes. For example, the memory device 86 may store processor-executable instructions 90 (e.g., firmware or software) for the processor 84 to execute, such as instructions for determining a plan.

In the illustrated example, the base station 44 includes a user interface 94 communicatively coupled to the computing system 82. The user interface 94 is configured to present data from the work vehicle 10 and/or the agricultural implement to an operator (e.g., data associated with the operation of the work vehicle 10, data associated with the operation of the agricultural implement, etc.). The user interface 94 is also configured to enable an operator to control certain functions of the work vehicle 10 (e.g., starting and stopping the work vehicle 10, instructing the work vehicle 10 to follow a route through the work area, identifying actions of the work vehicle 10 and corresponding action locations, etc.). In the illustrated embodiment, the user interface 94 includes a display 96 configured to present information to the operator, such as information about the work area, actions of the work vehicle 10, transition operations associated with actions, the position of the work vehicle 10 within the work area, the speed of the work vehicle 10, and the path of the work vehicle 10, among other data.

In the illustrated embodiment, the base station 44 includes a storage device 98 communicatively coupled to the computing system 82. The storage device 98 (e.g., nonvolatile storage) may include ROM, flash memory, a hard drive, or any other suitable optical, magnetic, or solid-state storage medium, or a combination thereof. The storage device(s) may store data, instructions (e.g., software or firmware for determining a plan, etc.), and any other suitable data. In some examples, the control system 46 may include the base station 44 or portion(s) thereof, such as the transceiver 92, the computing system 82, the user interface 94, and/or the storage device 98. In various examples, the control system may include other and/or additional controllers/control systems.

In various examples, the computing system 62 is configured to determine a plan for the work vehicle 10, including actions to be performed by the work vehicle 10 within the work area (e.g., a field), locations of the actions (e.g., action locations), and transition operations associated with the actions that enable the work vehicle 10 to perform the actions at the action locations. For example, prior to the operation of the work vehicle 10, the computing system 62 may determine a transition operation for each action that may facilitate the performance of the action at a respective action location. The transition operation may include a transition action that is performed by the work vehicle 10 before the action and a transition location of the transition action. The transition operation (e.g., the transition action and the transition location) may depend on the associated action, the action location, a speed of the work vehicle 10 (e.g., initial speed, expected speed, etc.), a terrain of the work area, a type of the work vehicle 10, a type of the implement, an expected weight of the work vehicle 10 along the path of the work vehicle 10 (e.g., at the transition location, at the action location, and/or elsewhere), expected weather conditions during operation of the work vehicle, one or more user inputs, or a combination thereof. The computing system 62 may generate the plan for operating the work vehicle 10, including a path through the work area and the actions and transition operations performed along the path. In some examples, the computing system 62 may generate and/or modify the path based on the transition operations, the actions, the action locations, or a combination thereof. In various examples, the control system 46 may display the plan via the user interface 74 to enable a user to view, approve, and/or modify the plan. For example, the user may approve and/or modify the plan as a whole, each transition operation, or portion(s) of each transition operation.

In various examples, the work vehicle computing system 62 determines the plan and outputs instructions to execute the plan (e.g., outputs instructions to the movement control system 50 to direct the work vehicle 10 along the path). However, in further examples, the plan may be determined and/or instructions to execute the plan may be output by one or more other controllers (e.g., alone or in combination with the work vehicle computing system 62). For example, in various examples, the control system 46 includes the base station computing system 82. In such examples, the base station computing system 82 may determine the plan and output one or more signals indicative of the plan to the work vehicle computing system 62 (e.g., via the respective transceivers). The work vehicle computing system 62 may then output one or more signals indicative of instructions to execute the plan (e.g., instructions to the movement control system 50 to direct the work vehicle 10 along a path of the plan). In further examples, the base station computing system 82 may determine the plan and output one or more signals to the movement control system 50 and/or other components of the system (e.g., via the respective transceivers, via the work vehicle controller, etc.) indicative of instructions to execute the plan (e.g., instructions to direct the work vehicle along a path of the plan, etc.). In examples in which the control system 46 includes the base station computing system 82, the base station computing system 82 may determine the plan for multiple work vehicles and output one or more signals indicative of the plan (e.g., including respective paths of the plan) or instructions to execute the plan to each work vehicle 10 (e.g., to the controller of each work vehicle 10, to the movement control system 50 of each work vehicle 10, etc.).

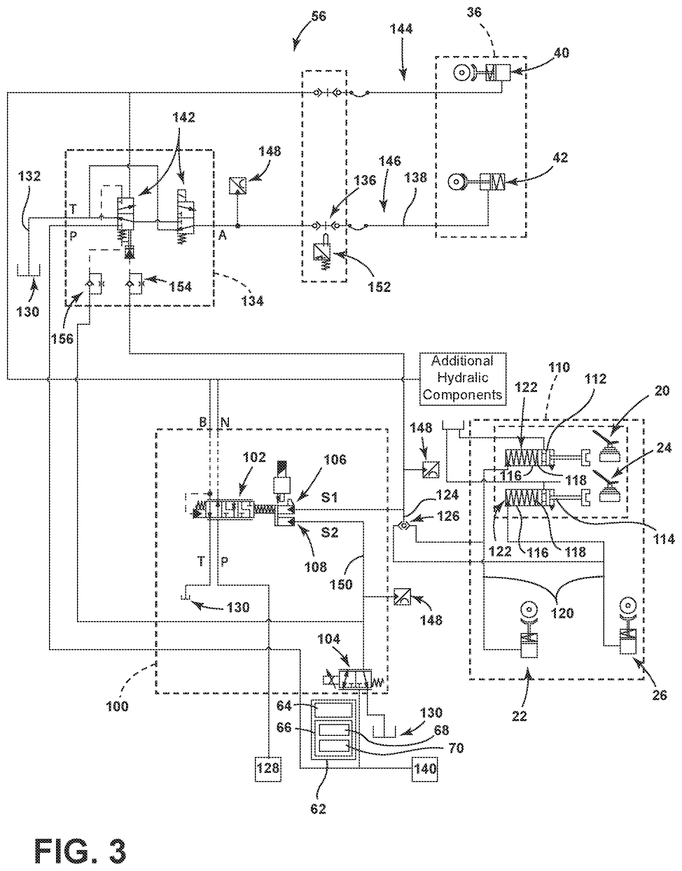

Referring now to FIG. 3, a schematic view of one embodiment of a brake control system 56 for providing speed-dependent control of one or more brakes of a trailer 34 hauled by a work vehicle 10 is illustrated in accordance with aspects of the present subject matter. In general, the brake control system 56 will be described herein with reference to the work vehicle 10 and the trailer 34 described above with reference to FIG. 1. However, it should be appreciated that, in general, the brake control system 56 may be utilized with any suitable work vehicle and/or any suitable trailer 34 configured to be towed or hauled by a work vehicle.

As shown in FIG. 3, the disclosed brake control system 56 may generally relate to a hydraulic braking arrangement for selectively actuating the trailer brake assembly 36 in response to the actuation of a trailer brake valve module 100 fluidly interposed between vehicle service brakes 22, 26 and trailer brake assembly 36 (e.g., the control line brakes 40 and/or the supplementary line brakes 42). Specifically, as will be described in greater detail below, the trailer brake valve module 100 can include a trailer brake valve 102 (e.g., a dual hydraulic pilot valve) and a control valve 104 (e.g., an electro-valve, such as an electronic proportional valve). When the vehicle 10 is operated in a manual mode and an operator actuates the vehicle service brakes 22, 26, a first signal S₁ is provided to a first port of the trailer brake valve 102, which in turn, can dictate the actuation (and/or the magnitude of actuation) of the trailer brake assembly 36. When the vehicle 10 is operated in an autonomous and/or semi-autonomous mode, a computing system 62 may actuate the control valve 104 to provide a second signal S₂ to a second port 108 of the trailer brake valve 102 that dictates the actuation (and/or the magnitude of actuation) of the trailer brake assembly 36 via a conduit 150.

As illustrated in FIG. 3, the brake control system 56 can include a vehicle brake module 110 configured to control the vehicle service brakes 22, 26 and the trailer brake valve module 100 fluidly interposed between the vehicle service brakes 22, 26 and the trailer brake assembly 36. In various examples, the vehicle brake module 110 can include at least a master brake cylinder 112, 114. In some cases, the vehicle brake module 110 can include a master brake cylinder 112, 114 for each of the vehicle service brakes 22, 26.

As illustrated in FIG. 3, each master brake cylinder 112, 114 can include a housing 116 and a piston 118 configured to slide inside the housing 116 that is further configured to house fluid in pressure. The housing 116 can be fluidly connected via an output conduit 120 to a respective vehicle service brake 22, 26. In some instances, the motion of the piston 118 inside the housing 116 tends to push away through conduit 8 the fluid in pressure thereby activating the respective vehicle service brake 22, 26. Additionally or alternatively, the piston 118 may be actuated by a first brake input device 20 and/or a second brake input device 24 so that the user, by actuating the first brake input device 20 and/or the second brake input device 24, can move the piston 118 within the housing 116. The presence of elastic assembly 122 can allow the countermotion of the piston 118 in its rest position within the housing 116. It will be appreciated that the vehicle brake module 110 can include other valve elements without departing from the scope of the present disclosure.

With further reference to FIG. 3, the vehicle brake module 110 can be fluidly connected to the trailer brake valve module 100 via a conduit 124 fluidly connecting with output conduits 120 of each master cylinder 112, 114. In particular, such connection can be achieved by a shuttle valve 126 fluidly interposed between the pair of output conduits 120 and the conduit 124. Such shuttle valve 126 can allow the passage of the greater fluid coming from the respective conduit 120 linked to the left or the right vehicle service brake 22, 26. The conduit 124 may further couple with the trailer brake valve 102 and provide the first signal S₁ (e.g., a hydraulic pilot signal) that can dictate the actuation (and/or the magnitude of actuation) of the trailer brake assembly 36.

Referring still to FIG. 3, in some examples, the control valve 104 can be configured to provide the second signal S₂ (e.g., a hydraulic pilot signal) to control the trailer brake valve 102 by modulating the fluid in pressure coming from a source 128 of fluid in pressure of the work vehicle 10, such as a pump or an accumulator. In several examples, the control valve 104 may be configured as an electronic valve, such as an electronic proportional valve, configured to modulate the fluid coming from the source 128 to generate the second signal S₂ having a pressure varying between a maximum value equal to the pressure of such fluid coming from source 128 and a minimum value by fluidly connecting the second signal S₂ to a tank 130.

In various examples, the trailer brake valve 102 can be a four-way proportional valve configured to regulate the fluid passage between source 128, the tank 130, and a trailer brake conduit 132 fluidly directed to the trailer brake assembly 36. The control valve 104 can be configured to modulate the fluid coming from the source 128 to flow towards trailer brake conduit 132 with a pressure varying between a maximum value equal to the pressure of such fluid coming from source 128 and a minimum value by fluidly connecting the trailer brake conduit 132 to tank 130.

As illustrated, in various examples, the trailer brake assembly 36 may include a control line brake 40 and a supplementary line brake 42 for allowing the control of trailer brake assembly 36 in case of emergency. In such instances, the brake control system 56 can include a safety valve manifold 134 can be configured to fluidly connect trailer brake conduit 132 with the control line brakes 40 while a supplementary line coupler 136 is configured to allow the connection of supplementary line brakes 42 to a supplementary line 138. The supplementary line 138 can fluidly be connected to a source of fluid source 140. Safety valves 142 are configured to allow or deny the fluid passage on a supplementary line 138 towards the supplementary line brakes 42 according to a signal.

In various examples, the control line brakes 40 may form and/or be part of a first fluid circuit 144, and the supplementary line brake 42 may form and/or be part of a second fluid circuit 146. In various examples, the first fluid circuit 144 may be independent and/or fluidly segregated from the second fluid circuit 146. Moreover, the fluid within the first fluid circuit 144 may be a first fluid, and the fluid within the second fluid circuit 146 may be a second fluid that is varied from the first fluid. For instance, the first fluid may be a brake fluid (e.g., a “glycol” based fluid) and the second fluid may be a transmission fluid (e.g., “petroleum” based fluid). However, it will be appreciated that each of the first and second fluids may be common with one another and/or any other compound without departing from the scope of the present disclosure.

As illustrated in FIG. 3, in various examples, the brake control system 56 can further include one or more pressure sensors 148 configured to detect the pressure in some points of the brake control system 56. In some instances, such pressure sensors 148 can be configured as pressure transducers that can detect the pressure at least in conduit 124, supplementary line 138, conduit 150, the conduit fluidly coupling the source 128 of fluid in pressure of the work vehicle 10, and/or any other conduit or component of the brake control system 56. Furthermore, the brake control system 56 can further include one or more switches 152 configured to detect the coupling of couplers 136. The computing system 62 can be operably coupled with each of the pressure sensors 148 and/or the switch 152.

Referring further to FIG. 3, in operation, the computing system 62 may detect (either through user input, lack of user input, and/or any other method) whether the vehicle 10 is being operated in a manually operated mode or an autonomous/semi-autonomous mode. In addition, in various examples, the computing system 62 may also detect the coupling of the trailer 34 to the vehicle 10 either through user input, the connection of the trailer 34 to the vehicle 10 (e.g., detection through a coupler switch), and/or any other method.

During the manually operated mode, the computing system 62 can energize the trailer braking valve when a shuttle lever is not in park and/or a mechanical brake (or electronic brake) is released. In such instances, when the operator presses the vehicle service brakes 22, 26, which may be one or more pedals, a pilot pressure from the brake input device 20, 24 operably coupled with the vehicle service brakes 22, 26 is applied to the shuttle valve 126. In addition, the pilot pressure is applied to a first port 106 of the trailer brake valve 102 as a first signal S₁. Based on the first signal S₁, the trailer brake valve 102 can allow port P to connect with Port B thereby allowing the trailer brake valve 102 to make the pump pressure available to the control line to apply the control line brake 40.

In addition, to achieve supplementary line braking, the safety valve manifold 134 may be provided with a pressure at Port P thereby allowing a valve within the safety valve manifold 134 to shift allowing for connection of port P to port A to release the supplementary line brake 42. In some cases, the supplementary line may be depressurized when the vehicle parking brake sensor detects when the vehicle 10 is in park. However, in the event of a control line failure or leak, a first pilot valve 154 may ensure that the pilot spool will shift to allow the supplementary pressure to leak from port A to port T thereby engaging the supplementary line brakes 42. In some examples, the computing system 62 may de-energize the control valve 104 so that there is not a second signal S₂ provided to the trailer brake valve 102. Additionally, or alternatively, by de-energizing the trailer control valve 104, no pressure is provided to a second pilot valve 156.

In some cases, the trailer brake valve 102 may be configured to have an advanced pressure such that the trailer brake conduit 132 experiences the advanced pressure independent of a first signal S₁ and/or a second signal S₂. In some cases, the advanced pressure may assist in sequencing the brake control system 56. In such instances, the control line brake 40 (e.g., a service brake) may be actuated a defined time (e.g., 40 milliseconds) to assist in the prevention of a jackknifing condition.

When an autonomous/semi-autonomous mode is initiated, the computing system 62 may verify that such mode is to be completed by detecting one or more user inputs. For instance, in some cases, the vehicle 10 may perform a brake test before initiating an autonomous/semi-autonomous mode.

During the autonomous/semi-autonomous mode, the computing system 62 can energize the control valve 104 thereby allowing a proportional pilot pressure to be provided to the second port 108 of the trailer brake valve 102 as a second signal S₂ through the conduit 150. In such instances, the trailer brake valve 102 may shift proportionally allowing the connection of port P to port B such that pump pressure is available to the control line to apply the trailer brake assembly 36.

In addition, to achieve supplementary line braking, the safety valve manifold 134 may be provided with a pressure at Port P thereby allowing a valve within the safety valve manifold 134 to shift allowing for the connection of port P to port A to release the supplementary line brake 42. In some cases, the supplementary line may be depressurized when the vehicle parking brake sensor detects when the vehicle 10 is in park. However, in the event of a control line failure or leak, the second pilot valve 156 may ensure that the pilot spool will shift to allow the supplementary pressure to leak from port A to port T thereby engaging the supplementary line brake 42.

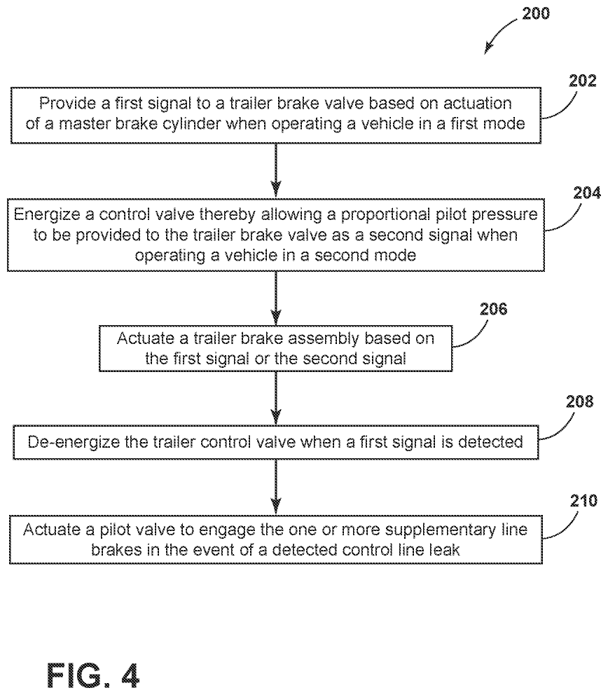

Referring now to FIG. 4, a flow diagram of a method 200 for operating a brake control system is illustrated in accordance with aspects of the present subject matter. In general, the method 200 will be described herein with reference to the agricultural vehicle 10 shown in FIGS. 1-3. However, it will be appreciated that the disclosed method 200 may be implemented with agricultural machines having any other suitable machine configurations and/or within systems having any other suitable system configuration without deviating from the present disclosure. In addition, although FIG. 4 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

As illustrated in FIG. 4, at (202), the method 200 can include providing a first signal to a trailer brake valve based on the actuation of a master brake cylinder when operating a vehicle in a first mode. As provided herein, the first mode may be a manually operated mode. When the vehicle is operated in a manual mode and an operator actuates the vehicle service brakes, a first signal is provided to the trailer brake valve, which in turn, can dictate the actuation (and/or the magnitude of actuation) of the trailer brake assembly.

At (204), the method can include energizing a control valve thereby allowing a proportional pilot pressure to be provided to the trailer brake valve as a second signal when operating a vehicle in a second mode. As provided herein, the second mode may be a semi-autonomous or autonomous mode. When the vehicle is operated in an autonomous and/or semi-autonomous mode, the actuation of the control valve can dictate the actuation (and/or the magnitude of actuation) of the trailer brake assembly.

At (206), the method 200 can include actuating a trailer brake assembly based on the first signal or the second signal. As provided herein, the trailer brake assembly can include one or more control line brakes fluidly coupled with a first fluid circuit and one or more supplementary line brakes fluidly coupled with a second fluid circuit. The first or second signal can dictate the actuation (and/or the magnitude of actuation) of the one or more control line brakes.

At (208), the method 200 can include de-energizing the trailer control valve when a first signal is detected. At (210), the method 200 can include actuating a pilot valve to engage the one or more supplementary line brakes in the event of a detected control line leak.

In various examples, the method 200 may implement machine learning methods and algorithms that utilize one or several machine learning techniques including, for example, decision tree learning, including, for example, random forest or conditional inference trees methods, neural networks, support vector vehicles, clustering, and Bayesian networks. These algorithms can include computer-executable code that can be retrieved by the computing system and/or through a network/cloud and may be used to evaluate and update the boom deflection model. In some instances, the machine learning engine may allow for changes to the boom deflection model to be performed without human intervention.

It is to be understood that the steps of any method disclosed herein may be performed by a computing system upon loading and executing software code or instructions that are tangibly stored on a tangible computer-readable medium, such as on a magnetic medium, e.g., a computer hard drive, an optical medium, e.g., an optical disc, solid-state memory, e.g., flash memory, or other storage media known in the art. Thus, any of the functionality performed by the computing system described herein, such as any of the disclosed methods, may be implemented in software code or instructions that are tangibly stored on a tangible computer-readable medium. The computing system loads the software code or instructions via a direct interface with the computer-readable medium or via a wired and/or wireless network. Upon loading and executing such software code or instructions by the computing system, the computing system may perform any of the functionalities of the computing system described herein, including any steps of the disclosed methods.

The term “software code” or “code” used herein refers to any instructions or set of instructions that influence the operation of a computer or controller. They may exist in a computer-executable form, such as vehicle code, which is the set of instructions and data directly executed by a computer's central processing unit or by a controller, a human-understandable form, such as source code, which may be compiled to be executed by a computer's central processing unit or by a controller, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a controller.

This written description uses examples to disclose the technology, including the best mode, and also to enable any person skilled in the art to practice the technology, including making and using any devices or systems and performing any incorporated methods. The patentable scope of the technology is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A brake control system comprising:
a trailer brake valve fluidly interposed between a vehicle brake assembly and a trailer brake assembly;
a brake module operably coupled with the vehicle brake assembly and configured to provide a first signal to the trailer brake valve; and
a control valve configured to provide a second signal to the trailer brake valve,
wherein the trailer brake valve is operated based on the first signal when a vehicle is operated in a first mode and operated based on the second signal when the vehicle is operated in a second mode.

2. The brake control system of claim 1, wherein the first mode is a manually operated mode and the second mode is an autonomous mode.

3. The brake control system of claim 1, wherein the first mode is a manually operated mode and the second mode is a semi-autonomous mode.

4. The brake control system of claim 1, further comprising:
a safety valve manifold interposed between the trailer brake valve and the trailer brake assembly.

5. The brake control system of claim 4, wherein the trailer brake assembly includes one or more control line brakes and one or more supplementary line brakes.

6. The brake control system of claim 5, wherein the one or more control line brakes are fluidly coupled with a first fluid circuit and the one or more supplementary line brakes are fluidly coupled with a second fluid circuit, the first fluid circuit segregated from the second fluid circuit.

7. The brake control system of claim 6, wherein a first fluid is provided within the first fluid circuit and a second fluid is provided within the second fluid circuit, the first fluid varied from the second fluid.

8. The brake control system of claim 7, wherein the first fluid includes a glycol compound and the second fluid includes a petroleum compound.

9. The brake control system of claim 1, wherein the control valve is configured as an electronic proportional valve.

10. The brake control system of claim 1, wherein the trailer brake valve is configured as a four-way proportional valve.

11. The brake control system of claim 5, further comprising:
a computing system communicatively coupled to the control valve, the computing system including a processor and associated memory, the memory storing instructions that, when implemented by the processor, configure the computing system to:
determine a braking pressure of the vehicle; and
actuate the control valve to provide the second signal to the trailer brake valve that dictates a magnitude of actuation of the trailer brake assembly.

12. The brake control system of claim 11, wherein the computing system is further configured to:
actuate a pilot valve to engage the one or more supplementary line brakes in an event of a detected control line leak.

13. A method for operating a brake control system, the method comprising:
providing a first signal to a trailer brake valve based on an actuation of a master brake cylinder when operating a vehicle in a first mode;
energizing a control valve thereby allowing a proportional pilot pressure to be provided to the trailer brake valve as a second signal when operating a vehicle in a second mode; and
actuating a trailer brake assembly based on the first signal or the second signal.

14. The method of claim 13, further comprising:
de-energizing the control valve when a first signal is detected.

15. The method of claim 13, wherein the trailer brake assembly includes one or more control line brakes fluidly coupled with a first fluid circuit and one or more supplementary line brakes fluidly coupled with a second fluid circuit.

16. The method of claim 15, further comprising:
actuating a pilot valve to engage the one or more supplementary line brakes in an event of a detected control line leak.

17. A brake control system comprising:
a trailer brake valve fluidly interposed between a vehicle brake assembly and a trailer brake assembly, the trailer brake assembly including one or more control line brakes fluidly coupled with a first fluid circuit and one or more supplementary line brakes fluidly coupled with a second fluid circuit;
a brake module operably coupled with the vehicle brake assembly and configured to provide a first signal to the trailer brake valve; and
a control valve configured to provide a second signal to the trailer brake valve,
wherein the trailer brake valve is operated based on the first signal when a vehicle is operated in a first mode and operated based on the second signal when the vehicle is operated in a second mode, and
wherein the first fluid circuit is segregated from the second fluid circuit.

18. The brake control system of claim 17, wherein the first mode is a manually operated mode and the second mode is an autonomous mode.

19. The brake control system of claim 17, wherein the first mode is a manually operated mode and the second mode is a semi-autonomous mode.

20. The brake control system of claim 17, further comprising:
a safety valve manifold interposed between the trailer brake valve and the trailer brake assembly.
